(19) United States
(12) Patent Application Publication
(10) Pub. No.: US 2012/0030022 A1
(43) Pub. Date: Feb. 2, 2012

(54) ELECTRONIC BOOK SYSTEM AND CONTENT SERVER

(75) Inventor: Yukinao Ajima, Tokyo (JP)

(73) Assignee: For-side.com Co., Ltd., Tokyo (JP)

(21) Appl. No.: 12/997,270

(22) PCT Filed: May 24, 2010
(86) PCT No.: PCT/JP10/58736

§ 371 Date: Dec. 10, 2010

(51) Int. Cl. G06F 3/01; G06F 15/16; G06Q 30/02

(52) U.S. Cl. 705/14.53; 715/738

(57) ABSTRACT

An electronic book system which enables selecting and distributing music matching contents etc. of an electronic book and playing the selected music upon browsing the electronic book. A typical embodiment of the present invention includes a content server and a terminal having a viewer for browsing electronic books and playing music, the viewer including an electronic book playback portion which plays and displays electronic books and a music playback portion which plays music. The content server includes an electronic book information DB which retains attribution information of electronic books, a music information DB which retains attribution information of music, an electronic book distribution portion which distributes electronic books, a music distribution portion which distributes music, and a music selection portion which selects music having attribution information matching attribution information of an electronic book currently being browsed by a user from the music information DB and specifies the selected music and makes the music distribution portion distribute the selected music.

### CROSS REFERENCE TO RELATED APPLICATIONS

This application is entitled to the benefit of and incorporates by reference essential subject matter disclosed in International Patent Application No. PCT/JP2010/58736 filed on May 24, 2010.

### TECHNICAL FIELD

The present invention relates to a technology for providing an electronic book service, more particularly, the present invention relates to a technology effectively applied to an electronic book system and a content server which enable playing music relating to a browsing electronic book at the same time.

### BACKGROUND ART

In recent years, release and use of publications by means of electronic books have been rapidly spreading. The factors of this include the widespread use of a mobile terminal such as a mobile phone capable of browsing the content of the electronic book in addition to the PC (Personal Computer) and others. Furthermore, the use of dedicated terminals for browsing the electronic book using the technology of electronic paper and others has also been spreading recently. Meanwhile, distribution services of music content to PCs and mobile terminals are widely provided, and mobile terminals are often used as music players.

Some of electronic book contents include text data and/or image data accompanied with sound data such as sound effects and BGM, so that a sense of presence is improved as a viewer suitably plays the sound data in accordance with a browsing state of the electronic book. Further, a technology of distributing and playing music relating to an electronic book online as needed instead of BGM previously set in the electronic book has been proposed.

For example, Japanese Patent Application Laid-Open Publication No. 2010-68044 describes an electronic book display system including: a track distributing device including a music data distribution unit which distributes music data relating to bibliographic information of an electronic book; and an information processing device including a music data receiving unit which receives music data, a related information receiving unit which obtains related information relating to the music data, a purchase reception unit which accepts purchasing of product related to the track data, and a purchase information transfer unit which transfers purchase information related to the accepted product to an external payment device, the electronic book display system enabling browsing of electronic books with a sense of presence by playing track data corresponding to electronic book data, and further enabling a display of the related information on a display device and transfer of the related information to a mobile terminal device, and creation of opportunities of purchasing products.

### DISCLOSURE OF THE INVENTION

When a user is browsing an electronic book, the presence and conformity during browsing can be improved by making the user able to browse with listening to BGM suitable with the content of the electronic book. In this situation, when the user can listen to not only fixed BGM previously accompanied with the electronic book but also BGM suitable with the user's likings and the current trend in the music market, the conformity would be improved more.

By the electronic book display system as described in Patent Document 1, distribution of music suitable with the content of the electronic book online, and playing that in accordance with browsing of the electronic book on the terminal side are possible. However, the electronic book display system of Patent Document 1 searches for music related to the bibliographic information of the electronic book and distributes the same, and it does not flexibly select recommended music in consideration of the user's attribution and/or preference to distribute the same nor distribute what they call “targeted advertising.”

In addition, by the electronic book display system in Patent Document 1, to compensate for content playability of a mobile terminal, acquisition of electronic book data from the mobile terminal and reception of music from the music distributing device are performed by the information processing device such as PC, and playback and output of the electronic book and music are performed to a display device such as TV. Thus, it is impossible to recommend music including music already purchased by the user and downloaded to the mobile terminal (i.e., music matching the user's preference).

Also, in recent years, along with spread of international roaming services by mobile phone communications carriers and spread of smartphones on globally common platforms represented by iPhone™, BlackBerry™, and Android™ terminal, distribution of content is being expanded across borders. In such a situation, for example, when browsing an electronic book purchased in Japan in foreign countries or vice versa, music, which should not normally be distributed against restrictions of copyright protection by a music copyright group in each country or region regarding the music, may be distributed and cause a copyright infringement. Meanwhile, the technology described in Patent Document 1 assumes a fixed terminal such as PC, and thus it does not consider such a content distribution and globalization of browsing environment.

Accordingly, a preferred aim of the present invention is to provide an electronic book system and a content server which selects music and/or advertisement etc. suitable with content of an electronic book and/or user's attribution, preference and so forth and distributes or instruct the same to a mobile terminal; the electronic book system and the content server enabling simultaneously playing selected music etc. when the user is browsing the electronic book on the mobile terminal; and the electronic book system and the content server enabling control of availability of distribution of music etc. after determining whether the mobile terminal exists in a distributable area or not. The above and other preferred aims and novel characteristics of the present invention will be apparent from the description of the present specification and the accompanying drawings.

The typical ones of the inventions disclosed in the present application will be briefly described as follows.

An electronic book system according to a typical embodiment of the present invention includes: a content server which retains and manages content containing an electronic book and music for providing services relating to browsing of electronic books and distribution of music via a network; and one or more terminals including a viewer having a function of browsing electronic books as being connected to the content server via the network and a function of playing music, the electronic book system having the following features.

More specifically, in the electronic book system, the viewer has an electronic book playback portion which plays and displays an electronic book specified by a user, and a music playback portion which plays music specified by the user or music selected by the content server.

Also, the content server has a feature in including: an information storage unit which retains attribution information of electronic books; a music information storage unit which retains attribution information of music; an electronic book distribution portion which refers to the electronic book information storage unit and distributes a specified electronic book to the electronic book playback portion to play the electronic book; a music distribution portion which distributes specified music to the music playback portion to play the music; and a music selection portion which obtains first attribution information of the electronic book being currently browsed on the viewer by the user from the electronic book information storage unit, selects music having second attribution information matching the obtained first attribution information from the music information storage unit to designate the selected music to the music distribution portion to distribute the same.

Moreover, the present invention can be also used in a content server used in the electronic book system described above.

The effects obtained by typical aspects of the present invention will be briefly described below.

According to the typical embodiment of the present invention, by selecting music, advertising, etc. matching contents of the electronic book, the user's attribution, preference, etc., and distributing or instructing the music, advertising, etc., it is possible to play the selected music etc. at the same time when the user is browsing the electronic book on the mobile terminal.

### BRIEF DESCRIPTION OF THE DRAWINGS

FIG. 1 is a diagram illustrating a summary of a configuration example of an electronic book system which is an embodiment of the present invention;

FIG. 2 is a diagram illustrating an example of a data configuration of a member DB in the embodiment of the present invention;

FIG. 3 is a diagram illustrating an example of a data configuration of a store DB in the embodiment of the present invention;

FIG. 4 is a diagram illustrating an example of a data configuration of a purchase history DB in the embodiment of the present invention;

FIG. 5 is a diagram illustrating an example of a data configuration of an electronic book information DB in the embodiment of the present invention;

FIG. 6 is a diagram illustrating an example of a data configuration of a music information DB in the embodiment of the present invention;

FIG. 7 is a diagram illustrating an example of a data configuration of an advertisement information DB in the embodiment of the present invention;

FIG. 8 is a diagram illustrating an example of a data configuration of a distributable area DB in the embodiment of the present invention;

FIG. 9 is a diagram illustrating an example of a flow of processings upon playing music etc. as BGM at the same time when browsing an electronic book in the embodiment of the present invention;

FIG. 10 is a diagram illustrating an example of a flow of processings upon performing various operations related to the music during browsing of the electronic book in the embodiment of the present invention;

FIGS. 11A-11D are diagrams illustrating screen examples upon playing music at the same time when browsing an electronic book in the embodiment of the present invention;

FIGS. 12A-12B are diagrams illustrating screen examples upon performing display of a playlist in the embodiment of the present invention;

FIGS. 13A-13B are diagrams illustrating screen examples upon performing search of music in the embodiment of the present invention.

### BEST MODE FOR CARRYING OUT THE INVENTION

Hereinafter, embodiments of the present invention will be described in detail with reference to the accompanying drawings. Note that components having the same function are denoted by the same reference symbols throughout the drawings for describing the embodiment, and the repetitive description thereof will be omitted.

An electronic book system, which is an embodiment of the present invention, is a system in which music, advertisement, etc. matching contents of an electronic book, a user's attribution, preference, etc. are selected and the music, advertisement, etc. are distributed or instructed to a mobile terminal after determining whether the mobile terminal exists in a distributable area or not in a content server which distributes electronic books and music, the electronic book system providing content distribution services capable of playing the music etc. selected by the content server as BGM at the same time when the user is browsing the electronic book by a viewer on the mobile terminal.

<System Configuration>

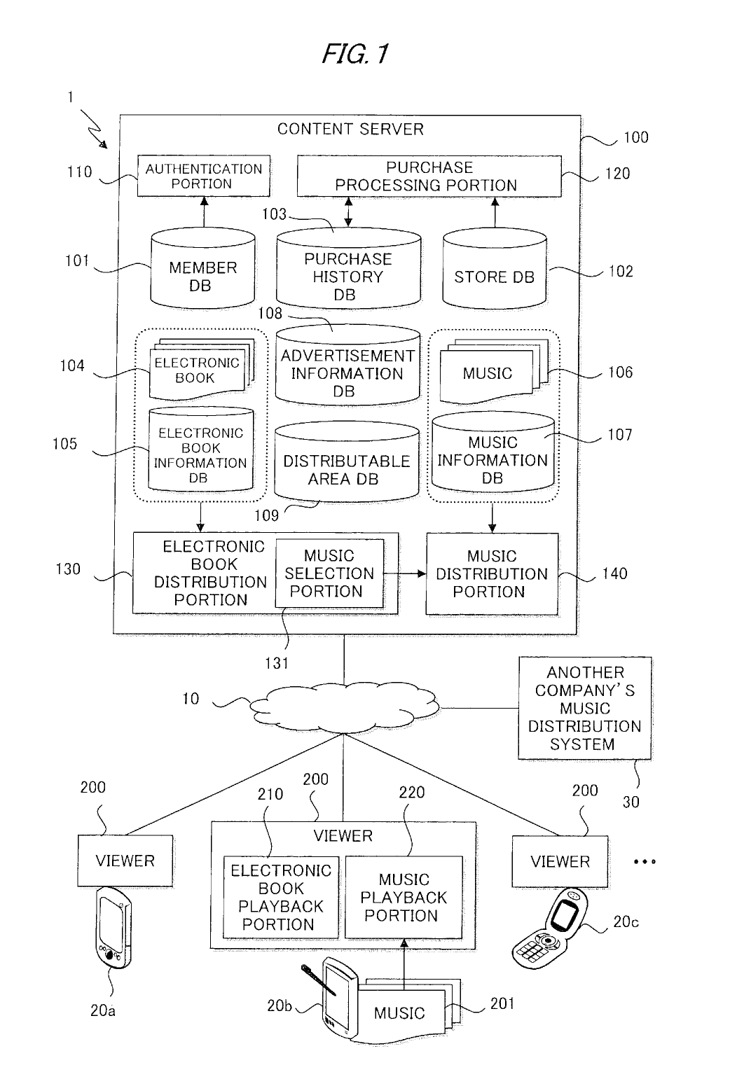

FIG. 1 is a diagram illustrating a summary of a configuration example of an electronic book system which is an embodiment of the present invention. An electronic book system 1 has a configuration in which various terminals 20 owned by users are connected to a content server 100 which distributes and manages contents containing electronic books and music via a network 10 such as the Internet etc. In addition, the content server 100 and the terminals 20 can be connected to another company's music distribution system 30 which provides a distribution service of music by another company via the network 10.

Here, “electronic book” means publication of contents of books like novels and comics, and publications of news, articles, etc. as contents of digital information, and it denotes those which can be browsed by a display as being distributed to an information processing device by streaming and/or browsing etc. Files of the electronic books are retained in the content server 100 as electronic books 104. In the present embodiment, users browse the electronic books by using a viewer which is software program for browsing electronic books on the terminals 20.

Also, “music” means distributed music etc. as digital information, and denotes music which can be played as being distributed to an information processing device by streaming and/or downloading. Music includes music in a track unit or an album unit, and further includes sample data of music as advertisement. Files of the music are retained in the content server 100 as music 106. In addition, music already obtained by downloading etc. from the content server 100 or the another company's music distribution system 30 by the users are retained in the terminals 20 as music 201.

The terminal 20 which is an information processing device for a user to browse an electronic book (electronic book 104) or play content such as music (music 106 or music 201) can be various types, for example, a smartphone (terminal 20a), a playback-only terminal of electronic books (terminal 20b), a general mobile phone etc. (terminal 20c) as long as the terminal can execute a viewer 200 compatible to the content. The viewer 200 is software program for browsing and playing contents and has each portion of an electronic book playback portion 210 which enables browsing of the electronic book 104 by playing it by streaming or browsing etc., and a music playback portion 220 which plays music (music 201 or music 106) directly or by streaming etc.

The content server 100 is formed of a computer system, and the content server 100 is a server system which manages content of the electronic books 104 and music 106 and provides browsing and playback services of the content by the viewer 200. The content server 100 has, for example, each portion mounted by software program of an authentication portion 110, a purchase processing portion 120, an electronic book distribution portion 130, and a music distribution portion 140. Also, the content server 100 has each data base or a table of a member DB 101, a store DB 102, a purchase history DB 103, an electronic book information DB 105, a music information DB 107, an advertisement information DB 108, and distributable area DB 109.

The authentication portion 110 performs a user authentication for determining whether the user is a member of the electronic book service provided by the electronic book system 1 or not by referring to the member DB 101 when the user of the terminal 20 carries out browsing of the electronic book 104 or playback of the music 106. Also, the authentication portion 110 may have a function of performing a user authentication to the another company's music distribution system 30 cooperating with the content server 100.

The purchase processing portion 120 performs processing upon purchase of the electronic book 104 or the music 106 by the user of the terminal 20. For example, the purchase processing portion 120 performs display of a Web site for purchasing content based on information of the store DB 102, addition of license information to the member DB 101 and/or the terminal 20 based on purchasing of content, download of content, payment processing relating to the purchase, etc. Contents of the purchase processing are stored in the purchase history DB 103. Upon displaying the Web site for purchasing content, a way of cooperation such as mutually directing to a purchasing Web site provided by the another company's music distribution system 30 may be carried out.

The electronic book distribution portion 130 has an interface which receives requests relating to browsing of the electronic book 104 from the terminal 20 through the viewer 200, and the electronic book distribution portion 130 enables browsing (playback) of the electronic book 104 by the electronic book playback portion 210 on the viewer 200. Note that, various attribution information pieces regarding the electronic book 104 used for specifying and playing the electronic book 104 are stored and managed by the electronic book information DB 105.

The electronic book distribution portion 130 further has a music selection portion 131 and performs processing for selecting the music 106 (or music 201 inside the terminal 20) matching the content of the browsing (playing) electronic book 104 or attribution and/or preference etc. of the user. The content of the electronic book 104 can be obtained from the electronic book information DB 105. Also, information regarding attribution of the user and/or preference to the content can be obtained from, for example, attribution information or history information retained in the member DB 101 and/or purchase history DB 103. Moreover, the advertisement information DB 108 may be referred to for selecting and playing music advertisement or sample music contained in the music 106 and/or the distributable area DB 109 may be referred to for determining a distributable area under copyright.

The music distribution portion 140 has an interface which receives request relating to playback of the music 106 from the terminal 20 through the viewer 200, and enables playback of the music 106 at the music playback portion 220 on the viewer 200 by a technology of distribution by, for example, general streaming etc. Note that, various attribution information pieces relating to the music 106 used for specifying and playing the music 106 are stored and managed in the music information DB 107.

Note that, while the music distributing portion 140, the music 106, and the music information DB 107 relating to music distribution are mounted on the content server 100 same as the electronic book distribution portion 130, the electronic book 104 and the electronic book information DB 105 in the present embodiment, portions relating to music distribution may be mounted on another content server when another music distribution service is already provided and so forth.

<Data Configuration>

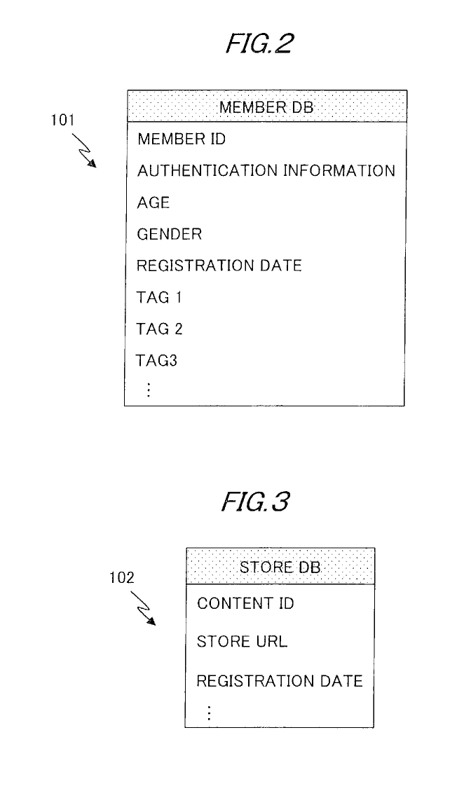

FIG. 2 is a diagram illustrating an example of a data configuration of the member DB 101. The member DB 101 is a table for managing account information of users who are members of the electronic book service provided by the electronic book system 1, and, for example, the member DB 101 contains each item of member ID, authentication information, age, gender, registration date, tags 1 to 3, etc.

The item of member ID retains ID information for uniquely identifying each user who is a member. That is, information of a user ID for the user to log in by accessing the content server 100 from the terminal 20 is retained. The item of authentication information retains information (for example, password etc.) for carrying out a user authentication for the target member (user) to log in to the content server 100. The items of age and gender retain information of age and gender as attribution information of the target user, respectively. Other information such as address or occupation may be retained in addition to these pieces of attribution information.

The item of registration date retains information of time and date of information of a target user registered to the member DB 101. The items of tags 1 to 3 retain information to be keywords for a search upon performing a criteria search for the music selection portion 131 of the electronic book distribution portion 130 to select the music 106. For example, a genre the target user is interested in and/or attribution information relating to preference such as favorite artists can be set as keywords as being specified by the user.

FIG. 3 is a diagram illustrating an example of a data configuration of the store DB 102. The store DB 102 is a table for managing information relating to the Web site for purchasing the music 106, and has each item of, for example, content ID, store URL, registration date, etc. The item of content ID retains ID information for uniquely identifying each content of the electronic book 104 and music 106.

The item of store URL retains information of a URL (Uniform Resource Locator) of the Web site (store) for purchasing target content. The item is not limited to a Web site for purchasing provided by the content server 100, and it may be a Web site provided by the another company's music distribution system 30. The another company's music distribution system 30 provides (places an ad), for example, the music 106 as a music sample for advertisement so that users who are interested in that are directed to own Web site for purchasing. The item of registration date retains information of time and date of registration of the target information to the store DB 102.

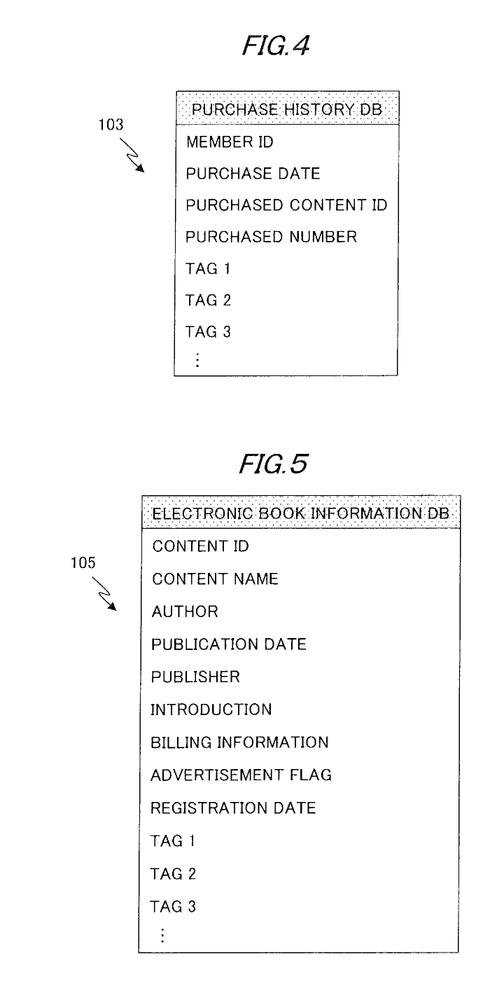

FIG. 4 is a diagram illustrating an example of a data configuration of the purchase history DB 103. The purchase history DB 103 is a table of managing information relating to a history of purchasing contents such as the electronic book 104 and/or music 106 by the user, that is, information relating to contents already purchased by the user, and the purchase history DB 103 has each item of, for example, member ID, purchase date, purchased content ID, number of purchased items, tags 1 to 3, etc.

The item of member ID retains information of member ID for specifying a user who purchased target content. The item of purchase date retains information about time and date when the user purchased the target content. The item of purchased content ID retains information of ID which specifies content such as the electronic book 104 or music 106 which the user has purchased. The item of number of purchase retains information of a number of contents the user has purchased. The items of tags 1 to 3 retain attribution information to be keywords for search upon performing a criteria search for the music selection portion 131 to select the music 106. For example, information of genre and/or category of the target content can be set as a keyword.

According to the purchase history DB 103 described above, tendency (preference) of purchase of the user can be grasped. From this point of view, other than the purchase history DB 103, a processing history DB, which retains information related to histories of various processings such as browsing and playback of contents of the electronic book 104 and music 106 carried out by accessing to the content server 100 by the target user in chronological order, may be provided.

FIG. 5 is a diagram illustrating an example of a data configuration of the electronic book information DB 105. The electronic book information DB 105 is a table for managing various attribution information pieces related to the electronic book 104, and has, for example, each item of content ID, content name, author name, publication date, publisher, introduction, billing information, advertisement flag, registration date, tags 1 to 3, etc.

The item of content ID retains ID information for uniquely authenticating the electronic book 104. For example, a file name (“A0001.tar” or the like) of the electronic book 104 can be used as a content ID. The item of content name retains information of a title of the electronic book 104. The items of author name, publication date, and publisher retain information of an author, a publication date, and a publisher of the target electronic book 104, respectively. The item of introduction retains information of an introduction added by the publisher or an operator of a distribution site about the target electronic book 104. The item of billing information retains information of a billing method or price for browsing the target electronic book 104.

The item of advertisement flag retains information of a flag indicating whether playback of music as an advertisement is allowed or not during browsing of the target electronic book 104. The item of registration date retains information of time and date of registration of the information of the target electronic book 104 to the electronic book information DB 105. The items of the tags 1 to 3 retain information to be a keyword for search upon performing a criteria search for the music selection portion 131 to select the music 106. For example, attribution information such as a genre and/or a category of the target electronic book 104 can be set as a keyword.

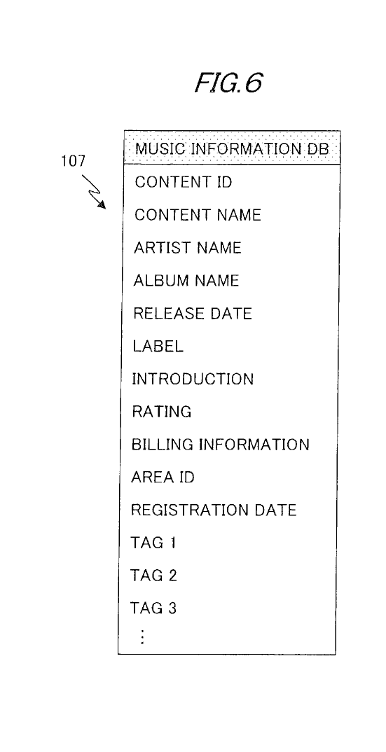

FIG. 6 is a diagram illustrating an example of a data configuration of the music information DB 107. The music information DB 107 is a table for managing various attribution information related to the music 106, and has, for example, each content of content ID, content name, artist name, album name, release date, label, introduction, rating, billing information, area ID, registration date, tags 1 to 3, etc.

The item of content ID retains, in the same manner as the content ID of the electronic book information DB 105, ID information for uniquely identifying the music 106. It is preferable that the ID information is also unique to the electronic book 104. The item of content name retains information of a title of the music 106. The items of artist name, album name, release date, and label retain information of a performance artist of the target music 106, a title of a recording album, a release date, and a producer/distributor label, respectively. The item of introduction retains information of an introduction added by a record company or an operator of a distribution site etc. about the target music 106. The item of rating retains information of a rating of each user about the target music 106. For example, the rating can be calculated by an average value of values rated by points or stages with respect to the target music 106 by each user.

The item of billing information retains information of a billing method and/or price for playback of the target music 106. The item of area ID retains, when a distributable area of the target music 106 is limited with regards to copyright etc., ID information for identifying the area (for example, “Japan”). The item of registration date retains information of time and date of registration of the target music 106 to the music information DB 107. The items of tags 1 to 3 retain information to be a keyword for search upon performing a criteria search for the music selection portion 131 to select the music 106. For example, attribution information such as a genre and/or category of the target music 106 can be set as a keyword.

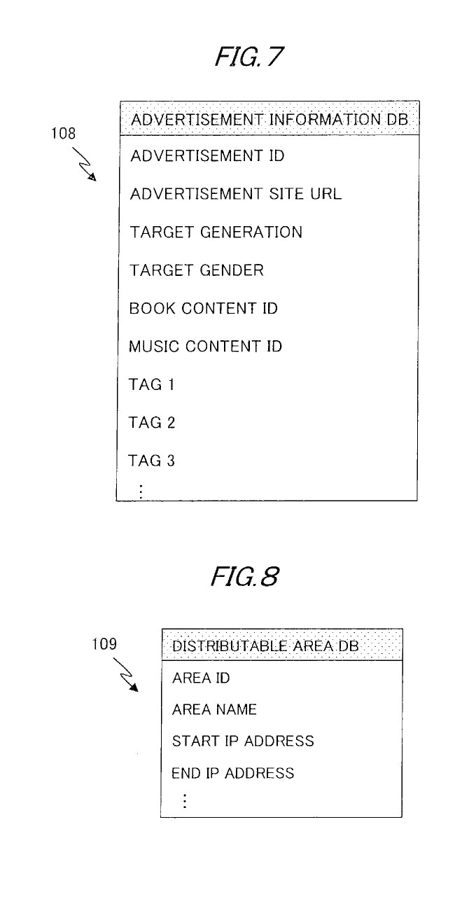

FIG. 7 is a diagram illustrating an example of a data configuration of the advertisement information DB 108. The advertisement information DB 108 is a table for managing information regarding target ads about music (music 106 and/or music distributed by the another company's distribution system 30), and has each item of, for example, advertising ID, advertizing site URL, target generation, target gender, book content ID, music content ID, tags 1 to 3, etc.

The item of advertisement ID retains information of an ID for uniquely identifying each advertisement information piece. The item of advertising site URL retains information of a URL of a Web site presenting advertisement information to the user. This is not limited to an advertising Web site provided by the content server 100 but maybe an advertising Web site provided (placed) by the another company's music distribution system 30. The items of target generation and target gender retain information of a generation and a gender of the target user for whom a target advertisement is presented, respectively.

The book content ID retains information of a content ID for specifying the electronic book 104 for which a target advertisement is presented. A plurality of the electronic books 104 can be specified, and the electronic book 104 can be specified by a matching of the tags 1 to 3 described later and the tags 1 to 3 of the electronic book information DB 105 instead of specifying the electronic book 104 by the content ID. The item of the music content ID retains information of a content ID for specifying music (for example, sample music data, advertising short omnibus etc.) corresponding to the target advertisement. A plurality of music pieces may be specified. The items of tags 1 to 3 retain information to be a keyword for selecting an advertisement to be presented to the browsing electronic book 104. For example, attribution information of a genre and/or a category of the music to be a target of an advertisement can be set as a keyword.

FIG. 8 is a diagram illustrating an example of a data configuration of a distributable area DB 109. The distributable area DB 109 is a table for managing information about each area when a distributable area (region) is limited in accordance with copyright etc., and has each item of, for example, area ID, area name, start IP address, end IP address, etc.

The item of area ID retains ID information for uniquely identifying each distributable area. The item of area name retains information about a name (country name, region name, etc.) of a target area. The items of start IP address and end IP address retain information relating to ranges of IP address of the terminal 20 predicted to exist in the target area.

In each table described above in the present embodiment, while there are tables specifying three tags of the tags 1 to 3, the number of specified tags is not limited to this, and it can be an arbitrary number. Also, the numbers of items and types of each of the tables described above are just examples, and it is needless to say that information managed by each of the tables described above may be retained by other data configurations.

<Processing Contents>

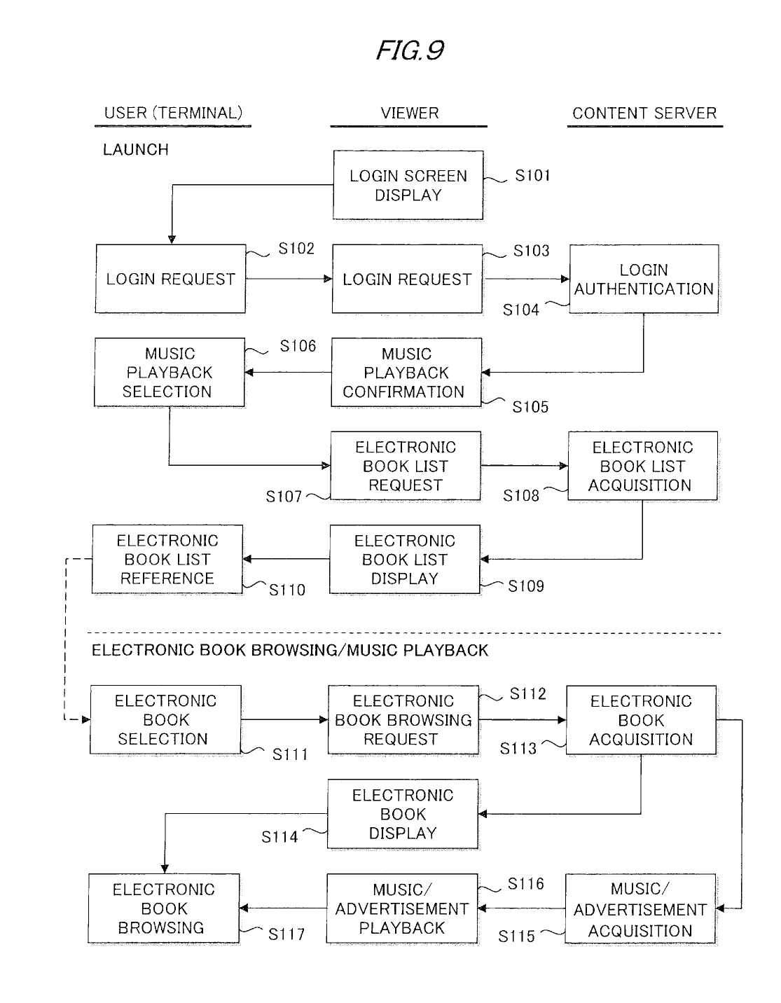

In the following, contents of processings in the electronic book system 1 of the present embodiment will be described. FIG. 9 is a diagram illustrating an example of a flow of processings upon playing the music 106 etc. at the same time of browsing the electronic book 104.

First, when the viewer 200 is launched on the terminal 20 by the user, the viewer displays a login screen (S101). When the user sends a login request by inputting his/her member ID and authentication information (S102), the viewer 200 transfers a login request to the content server 100 (S103). In the content server 100, the member DB 101 is referred by the authentication portion 110 to perform an authentication (user authentication) whether the user is a member of the electronic book service provided by the content server 100 or not (S104).

When the user authentication is valid, in the present embodiment, the viewer 200 asks the user whether he/she wishes to play the music 106 or the music 201 on the terminal 20 as BGM during browsing of the electronic book 104 or not (S105). When the user selects to play or not to play the music (S106), the viewer 200 requests a list of the electronic books 104 which the user can browse to the content server 100 (S107).

In the content server 100, information of the electronic book 104, which has been already purchased by the target user, is obtained from the purchase history DB 103 by the electronic book distribution portion 130, and a list of the electronic books 104 available to browse is created referring to the electronic book information DB 105, and the list is transferred to the viewer 200 (S108). In the situation, for example, the advertisement information DB 108 may be referred, and information may be added to the list as a target ad of the book, the information of a book content ID corresponding to an advertisement about a target generation, a target gender, and a genre (tags 1 to 3) matching the target user's age, gender, and/or interested genre (for example, the tags 1 to 3 in the member DB 101).

By displaying the list (and advertising) of the electronic books 104 on the viewer 200 based on transferred contents (S109), the user can refer to the list (or advertisement) of the electronic books 104 he/she can browse (S110). Note that, for example, when the user selects to play the music in the step S106, the viewer 200 may previously activate a function of the music playback portion 220 as a music player function upon displaying the list in the step S109.

Thereafter, when the user selects a desired electronic book 104 and requests browsing of the electronic book 104 (S111), the viewer 200 transfers a browsing request of the target electronic book 104 to the content server 100 (S112). In the content server 100, contents of the electronic book 104 which is the browsing target is obtained referring to the electronic book information DB 105 by the electronic book distribution portion 130, and the contents are transferred to the viewer 200 (S113). By displaying the contents of the electronic book 104 which is the browsing target by the electronic book playback portion 210 on the viewer 200 based on the transferred contents (S114), the user can browse the electronic book 104 which is the browsing target (S117).

Also, in the content server 100, for example, as a parallel processing to the step S113, the music 106 (or the music 106 as an advertisement), which matches the contents of the electronic book 104 which is the browsing target, an attribution and preference of the user, is selected by the music selection portion 131, and the music 106 is distributed to the viewer 200 by streaming etc. by the music distribution portion 140 (S115). By playing the music 106 on the viewer 200 by the music playback portion 220 based on the distributed contents (S116), during browsing of the electronic book 104, the music 106, which the content server 100 recommends as music which matches the electronic book 104, can be played as BGM.

In the step S115, the music selection portion 131 of the content server 100 refers to the electronic book information DB 105 to confirm a value of an advertisement flag of the target electronic book 104. When the advertisement flag is OFF, attribution information (tags 1 to 3) about the target electronic book 104 is obtained from the electronic book information DB 105 and the music information DB 107 is referred so that information about the music 106 matching attribution information (tags 1 to 3) is obtained referring to the music information DB 107. In this situation, when information of a store URL corresponding to the target music 106 is registered to the store DB 102, the information is also obtained together as associated information of the music 106.

When the advertisement flag of the electronic book 104 which is the browsing target is ON, for example, a content ID and/or attribution information (tags 1 to 3) about the target electronic book 104 are/is obtained from the electronic book DB 105, and further, attribution information (information of genres and/or artists purchased at the highest frequency in the past for the target user or other users of the same gender and same generation) is obtained from the member DB 101 and/or purchase history DB 103. By performing matching of these information pieces and book content IDs of the advertisement information DB 108 and/or attribution information (target generation, target gender, and/or tags 1 to 3), for example, when there is advertisement information hit regarding one or more items, information about the music 106 (for example, sample music data and/or a short omnibus for advertisement etc.) determined by the specified music content ID is obtained. In this situation, information of an advertising site URL is also obtained together as associated information of the music 106.

After obtaining the information of the music 106, information of an IP address of the terminal 20 of an access source is further obtained from a request message and/or information of network session etc. and together with the information of the distributable area DB 109, and whether the obtained music 106 is distributable or not is determined. Not distributable ones of music 106 are eliminated. When a plurality of music pieces 106 are obtained from a result of the processings described above, these pieces may be played in sequence, or, for example, a predetermined number of music pieces 106 may be selected randomly and played or a predetermined number of music pieces 106 selected in descending order of matched attribution information pieces may be selected and played.

FIGS. 11A to 11D are diagrams illustrating screen examples upon performing playback of the music 106 at the same time of browsing the electronic book 104 by the viewer 200. FIG. 11A is a diagram illustrating a screen example upon asking the user whether he/she wishes to play music as BGM during browsing of the electronic book 104 or not in the step S105 in FIG. 9 when activating the viewer 200 of the terminal 20. Here, when the user selects Yes or No (“Yes” in the example of FIGS. 11A and 11B) of playback of the music 106 in the step S106, and then the sequence of processings of the steps S107 to S117 are performed, the screen as illustrated in FIG. 11B is displayed, and playback of the music 106 recommended by the content server 100 is performed at the same time of browsing the electronic book 104.

Here, in the present embodiment, an example of displaying the electronic book 104 on a mobile terminal having a touch panel such as a smartphone is described. On the screen illustrated in FIG. 11B, for example, at an upper portion of the screen on which content of the electronic book 104 is displayed, a menu area 201 in which various menus and buttons etc. for performing operation to the viewer 200 by the user is included. Also, at a lower portion of the screen, in an aspect not to be a barrier of browsing the electronic book 104, a music information display area 202 in which simple information of a title, artist name, etc. about the music 106 being played is displayed is included.

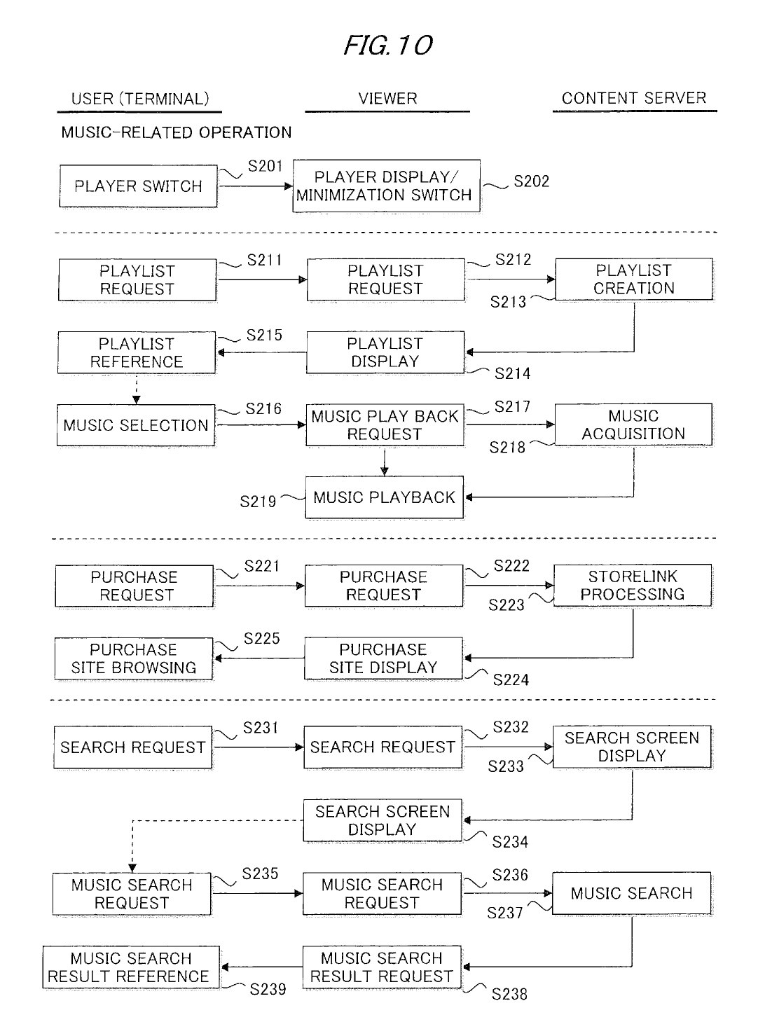

In this state, the user can carry out processings such as various operations regarding playback of the music 106 and purchasing of the music etc. at the same time of browsing the electronic book 104. FIG. 10 is a diagram illustrating an example of a flow of processings upon carrying out various operations relating to the music 106 (or the music 201) during browsing of the electronic book 104.

The user can switch music player functions (music playback portion 220) for controlling playback of the music (or the music 201) by calling and closing the functions as needed during browsing of the electronic book 104 on the viewer 200 (S201). Every time the viewer 200 receives instructions from the user, the viewer 200 alternately switches display/no-display of the music player function (S202).

In the screen of FIG. 11B described above, for example, when the user taps an arrow button at a right portion of the music information display area 202, as illustrated in FIG. 11C, a music player area 203 for controlling playback of the music 106 is displayed at a lower portion of the screen. Here, when the arrow button at the right portion of the music information display area 202 is tapped again, the music player area 203 is closed, and the screen is back to the screen of FIG. 11B. In this manner, the user can alternately switch display/no-display of the music player area 203 as needed.

In the music player area 203, in addition to operations such as play, stop, etc. of the music by the music playback portion 220, for example, when the user wishes to purchase the music 106 being played, by tapping a cart button at a right portion of the music player area 203, a Web site (not illustrated) for purchasing the music 106 being played can be displayed as described later. When the music 106 being played is an advertisement, a Web site (not illustrated) for advertising may be displayed.

Also, in the screen of FIG. 11C, for example, to know detailed information of the music 106 being played, by tapping a musical note button at a left portion of the music player area 203, a music detail information screen as illustrated in FIG. 11D is displayed. Here, generally contained functions as a music player such as instructions of volume control, repeat playback, and random playback etc.; and display of an album jacket image, rating, playback status, etc. are provided by the music playback portion 220.

To get back to FIG. 10, during browsing of the electronic book 104 on the viewer 200, the user can request display of a playlist about the music to be played (S211). The viewer 200 transfers an acquisition request of the playlist to the content server 100 upon receiving the request from the user (S212). In the music selection portion 131 of the content server 100, in the same process as obtaining information of the music 106 played in the step S115 in FIG. 9, information of the music 106 to play, that is, a playlist is created (updated) and transferred to the viewer 200 (S213). On the viewer 200, by displaying contents of the playlist based on the transferred contents (S214), the user can refer to the playlist (S215).

Here, when the viewer 200 requests a playlist in the step S212, the user may transfer information of the music 201 (title, artist name, etc.) already retained by the terminal 20 by download etc. together. In this manner, in the music selection portion 131 of the content server 100, the user can select recommended music including the music 201 retained in the terminal 20 by the user. In this situation, the music 201 retained by the terminal 20 may be included in the playlist by necessity, and also the music 201 may be integrally handled with the music 106 by raising/lowering priority to the music 106 on the content server in a matching with the attribution information of the electronic book 104.

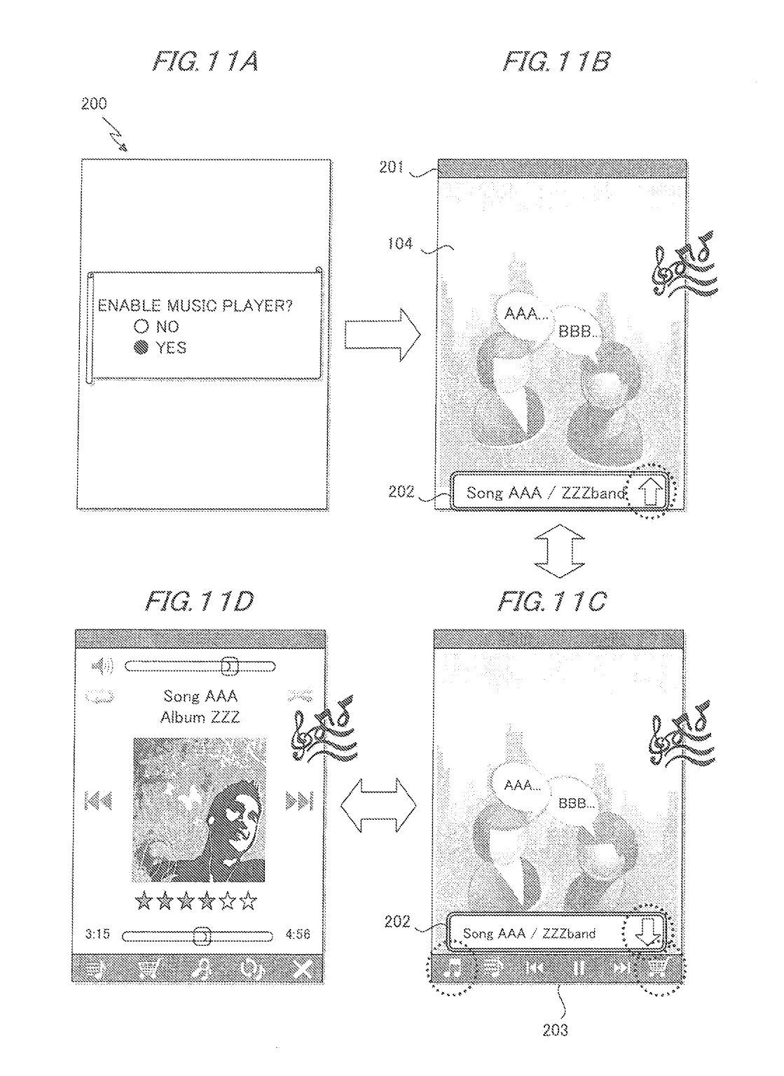

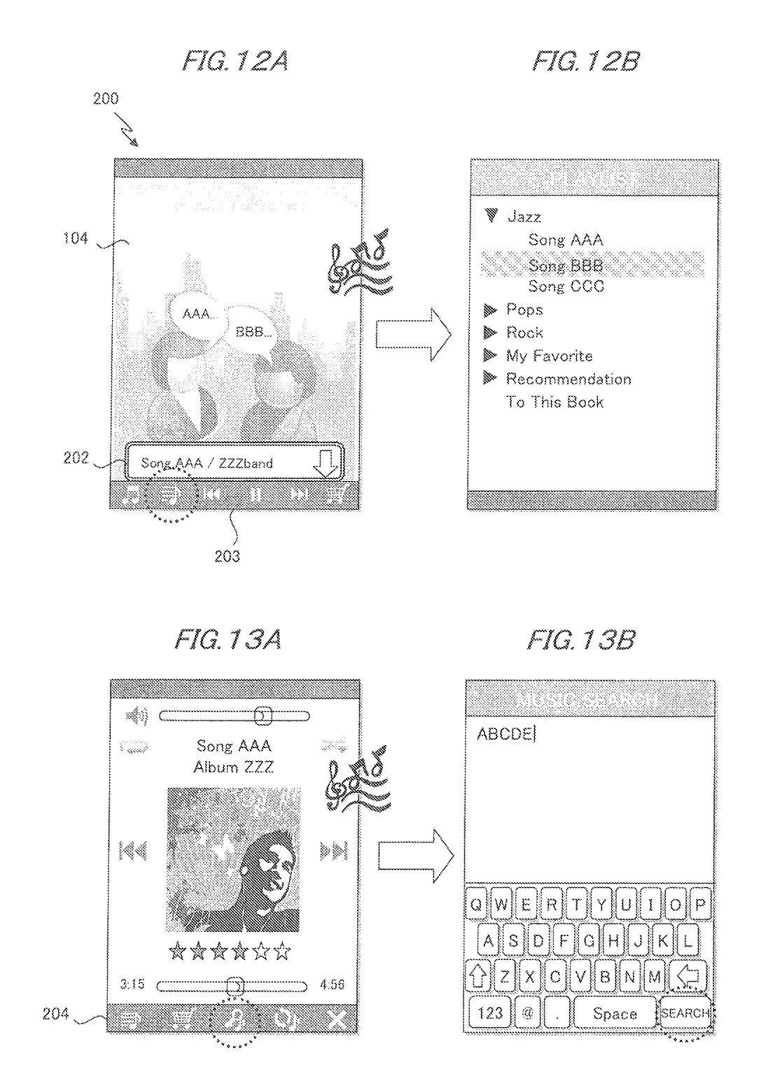

FIGS. 12A and 12B are diagrams illustrating screen examples upon performing a display of a playlist by the viewer 200. FIG. 12A illustrates a state in which music is played during browsing of the electronic book 104 and the music player area 203 is displayed in the same manner as FIG. 11C. Here, when the user taps a playlist button in the music player area 203, acquisition of the playlist is carried out by the music selection portion 131 in the content server 100, and, as illustrated in FIG. 12B, a playlist is displayed with a list of the music 201 already retained by the terminal 20.

Here, the playlist created by the music selection portion 131 of the content server 100 is displayed as “Recommendation For This Book” in the example of FIG. 12B, and when the user selects this, music (the music 106 or music 201) matching the electronic book 104 which the user is browsing can be played. Note that the user can use the terminal 20 as a general music player by selecting the music 201 already retained in the terminal 20.

To get back to FIG. 10, as described above, the user selects to play the desired music 201 or recommended music (the music 106 or music 201 specified in the playlist transferred from the content server 100) matching the browsing electronic book 104 from the playlist as illustrated in FIG. 12B (S216). The viewer 200 plays the music by the music playback portion 220 when the selected music is the music 201 retained in the terminal 20 (S217, S219).

Meanwhile, when the selected one is recommended music, music specified in the playlist transferred from the content server 100 is sequentially played. In this situation, when the music is the music 201 retained in the terminal 20, the music is directly played by the music playback portion 220 in the same manner as described above (S217, S219). On the other hand, when the music is the music 106 retained in the content server 100, a play request of the music 106 is sent to the content server 100 (S217). In the content server 100, the music information DB 107 is referred by the music distribution portion 140, and the music 106 is distributed (S218), and, in the viewer 200, the music 106 is played by the music playback portion 220 based on the distributed contents (S219).

In this manner, the music 201 already retained in the terminal 20 and the music 106 retained in the content server 100 are integrally handled and music matching the electronic book 104 can be played. Note that, upon creating the playlist in the content server 100 in the step S213, the music 201 retained in the terminal is used as an object in the playlist only when the music 201 is identical to the music 106 retained in the content server 100, and the playback may be standardized such that all playback is performed by distribution of the music 106 on the content sever 100.

When the user wishes to purchase the music 106 being played by distribution from the content server 100 during browsing of the electronic book 104, the user can send a request of purchasing the music 106 on the viewer 200 (S221). For example, in the screen of FIG. 11C, a cart button at a right portion of the music player area 203 is tapped. The viewer 200 transfers the purchase request together with information of the playing music 106 to the content server 100 (S222).

In the content server 100, by the purchase processing portion 120, whether the target music 106 has been already purchased or not is confirmed by referring to the purchase history DB 103, and a store link process of displaying a purchasing Web site of the target music 106 or an advertising Web site is performed when the music 106 has not been purchased yet (S223). Information of URLs of these Web sites can be obtained by referring to information which has been obtained as additional information upon obtaining information of the music 106 by the music selection portion 131 of the content server 100 in the step S115 in FIG. 9.

When the target music 106 is music distributed by the another company's distribution system 30, a Web site provided by the another company's distribution system 30 is displayed to guide. On the viewer 200, by displaying the purchasing Web site (or the advertizing Web site) instructed from the content server 100 (S224), the user can purchase the target music 106 as browsing the Web site (S225).

Also, the user can send a request for searching for the music 106 for playing it as BGM or purchasing it during browsing of the electronic book 104 (S231). The viewer 200 transfers a search request to the content server 100 (S232). At the content server 100, a search screen is displayed by, for example, the music distribution portion 140 (S233). In this situation, the search screen may be displayed after carrying out various settings for a later search. On the viewer 200, the search screen is displayed based on instructions from the content server 100 (S234).

FIG. 13 is a diagram illustrating a screen example upon performing a search of the music 106 on the viewer 200. For example, in the music detail information screen (in the same manner as FIG. 11D) as illustrated in FIG. 13A, as a search button in the menu area 204 at a lower portion of the screen is tapped by the user, a search screen as illustrated in FIG. 13B is displayed by the content server 100.

To get back to FIG. 10, the user inputs keywords such as a title of the music 106, an album name, an artist name etc. as search criteria, and a search request of the music 106 can be sent by tapping the search button at the lower portion of the screen (S235). The viewer 200 transfers the search request containing the specified keywords to the content server 100 (S236). In the content server 100, for example, the music information DB 107 etc. is referred by the music distribution portion 140, and a list of music hitting the search criteria is created from the music 106 distributed by the content server 100 or the another company's music distribution system 30 and the list is transferred to the viewer 200 (S237).

In the viewer 200, by displaying a search result of the music 106 based on the transferred contents (S238), the user can refer to the result (S239). The music 106 contained in the search result may be played or purchased as the user selects it.

As described in the foregoing, according to the electronic book system 1 which is an embodiment of the present invention, in the content server 100 which distributes the electronic book 104 and the music 106, the music 106 distributed by the content server 100 and/or the another company's music distribution system 30 and the music 201 retained in the terminal 20 are handled as a unit, and thus music and/or advertisement matching contents of the electronic book 104 , an attribution and/or preference of the user can be selected and distributed or instructed. Also, after determining whether the terminal 20 is in a distributable area or not, availability of distribution of the music 106 can be controlled.

In this manner, it is possible to provide a content distribution service capable of playing the music 106 etc. selected by the content server 100 as BGM at the same time when the user browses the electronic book 104 by the viewer 200 on the terminal 20, and it is possible to promote purchasing of music as well as to improve a sense of presence and the comfort level during browsing of the electronic book 104. Also, with addressing globalization of content distribution and browsing environment, it is possible to carry out a distribution of music while avoiding a copyright infringement.

In the foregoing, the invention made by the inventor of the present invention has been concretely described based on the embodiments. However, it is needless to say that the present invention is not limited to the foregoing embodiments and various modifications and alterations can be made within the scope of the present invention.

The present invention can be used in an electronic book system and a content server which enable playback of music etc. related to a browsing electronic book at the same time.

While the present invention has been illustrated and described with respect to a particular embodiment thereof, it should be appreciated by those of ordinary skill in the art that various modifications to this invention may be made without departing from the spirit and scope of the present.

1. An electronic book system which retains and manages content containing electronic books and music, the electronic book system comprising:
a content server which provides services relating to browsing of an electronic book via a network and distribution of music; and
one or more terminals including a viewer having a function of browsing electronic books and a function of playing music,
the viewer including:
an electronic book playback portion which plays and displays an electronic book specified by a user; and
a music playback portion which plays music specified by a user or music selected by the content server,
the content server including:
electronic book information storage means which retains attribution information of electronic books;
music information storage means which retains attribution information of music;
an electronic book distribution portion which refers to the electronic book information storage means and distributes a specified electronic book to the electronic book playback portion to play the specified electronic book;
a music distribution portion which refers to the music information storage means and distributes specified music to the music playback portion to play the specified music; and
a music selection portion which obtains first attribution information of an electronic book currently being browsed by the user on the viewer from the electronic book information storage means in accordance with instruction from the viewer, selects music having second attribution information matching the obtained first attribution information from the music information storage means, and specifies selected music and makes the music distribution portion distribute the selected music.

2. The electronic book system according to claim 1, wherein
the music playback portion of the viewer transfers information of music which has been already retained in the terminal to the music selection portion of the content server, and
the music selection portion of the content server selects music including music which has been already retained in the terminal relating to information received from the music playback portion upon selecting information of music having the second attribution information matching the first attribution information from the music information storage means.

3. The electronic book system according to claim 1, wherein
the music selection portion of the content server obtains the first attribution information from the electronic book information storage means in accordance with instruction from the viewer, selects music having the second attribution information matching the obtained first attribution information from the music information storage means, and transfers a list of selected music to the viewer.

4. The electronic book system according to claim 1, wherein
music retained by the content server contains music as an advertisement,
the content server further includes advertisement storage means which retains advertisement information including information of a target electronic book to present an advertisement and information and attribution information of music as an advertisement to be presented, and
the music selection portion obtains the first attribution information from the electronic book information storage means in accordance with instruction from the viewer, identifies advertisement information having: information of an electronic book matching third attribution information matching one or more of the first attribution information having been obtained, attribution information of the user, attribution information obtained from a purchasing history of contents in the past of the user; or alternatively, information of the electronic book currently being browsed, and specifies music as an advertisement contained in the advertisement information to the music distribution portion and makes the music distribution portion to distribute the music as an advertisement.

5. The electronic book system according to claim 1, wherein
the content server retains information of a distributable area per music in the music information storage means,
the content server further includes distributable area storage means which manages information relating to a correspondence of a target area to distribute music and a range of IP address of the terminal determined to be in the area, and
the music selection portion refers to the distributable area storage means based on an IP address of the terminal to be connected upon selecting information of music having the second attribution information matching the first attribution information from the music information storage means, and determines availability of distribution to the terminal regarding selected music.

6. A content server which retains and manages contents containing electronic books and music, and
provides services relating to browsing of electronic books and distribution of music via a network,
the content server comprising:
electronic book information storage means which retains attribution information of electronic books;
music information storage means which retains attribution information of music;
an electronic book distribution portion which refers to the music information storage means and distributes specified music to the viewer to play the specified music; and
a music selection portion which obtains first attribution information of an electronic book currently being browsed by a user on the viewer from the electronic book information storage means in accordance with instruction from the viewer, selects music having second attribution information matching the obtained first information from the music information storage means, and specifies selected music and makes the music distribution portion distribute the selected music.
